(19) United States
(12) Patent Application Publication
(10) Pub. No.: US 2020/0078918 A1
(43) Pub. Date: Mar. 12, 2020

(54) IMPACT TOOL

(71) Applicant: MAKITA CORPORATION, Anjo-shi (JP)

(72) Inventors: Kiyonobu YOSHIKANE, Anjo-shi (JP); Yoshiro TADA, Anjo-shi (JP); Yoshitaka MACHIDA, Anjo-shi (JP)

(73) Assignee: MAKITA CORPORATION, Anjo-shi (JP)

(21) Appl. No.: 16/564,492

(22) Filed: Sep. 9, 2019

(30) Foreign Application Priority Data
Sep. 10, 2018 (JP) 2018-169243

(51) Int. Cl. B25D 11/00; B25F 5/00

(52) U.S. Cl. CPC B25D 11/005; B25F 5/001; B25D 2250/201; B25D 2250/095; B25D 2250/221; B25D 2216/0023

(57) ABSTRACT

An impact tool includes a motor, a driving mechanism, a body housing, a battery-mounting part, a first detection part and a control part. The driving mechanism is configured to linearly drive a tool accessory along a driving axis by power of the motor, the driving axis extending in a front-rear direction of the impact tool. The body housing houses the motor and the driving mechanism. The battery-mounting part is configured to removably receive a battery. The first detection part is configured to detect a rearward push of the tool accessory relative to the body housing. The control part is configured to start driving of the motor in response to detection of the rearward push of the tool accessory by the first detection part.

### CROSS-REFERENCE TO RELATED APPLICATION

The present application claims priority to Japanese patent application No. 2018-169243 filed on Sep. 10, 2018, the contents of which are fully incorporated herein by reference.

### TECHNICAL FIELD

The present invention relates to an impact tool which is configured to linearly drive a tool accessory.

### BACKGROUND ART

An impact tool is known which performs an operation (for example, a chipping operation) on a workpiece by linearly driving a tool accessory along a specified driving axis. In such an impact tool, a motor may be controlled to be driven at low speed in a state in which the tool accessory is not pressed against a workpiece and no load is applied (hereinafter referred to as an unloaded state), while being controlled to be driven at higher speed in a state in which the tool accessory is pressed against a workpiece and a load is applied (hereinafter referred to as a loaded state) (see, for example, Japanese unexamined patent application publication No. 2018-58188).

### SUMMARY

The impact tool disclosed in Japanese unexamined patent application publication No. 2018-58188 can realize power saving in the unloaded state. In an impact tool powered by a battery, however, further power saving may be desired to extend the available time (or so-called runtime) of a fully charged battery.

It is, accordingly, an object of the present disclosure to provide a technique which may contribute to further power saving of an impact tool powered by a battery.

According to one aspect of the present disclosure, an impact tool is provided which includes a motor, a driving mechanism, a body housing, a battery-mounting part, a first detection part and a control part.

The driving mechanism is configured to linearly drive a tool accessory along a driving axis by power of the motor. The driving axis extends in a front-rear direction of the impact tool. The body housing houses the motor and the driving mechanism. The battery-mounting part is configured to removably receive a battery, which is a power source of the motor. The first detection part is configured to detect a rearward push of the tool accessory relative to the body housing. The control part is configured to control driving of the motor. Further, the control part is configured to start driving of the motor in response to detection of the rearward push of the tool accessory by the first detection part. Here, the rearward push may be rephrased as a pressing of the tool accessory against a workpiece.

### BRIEF DESCRIPTION OF THE DRAWINGS

FIG. 1 is a right side view of an electric hammer of a first embodiment, in the state where a second housing is placed in a rearmost position.

FIG. 2 is a sectional view of the electric hammer shown in FIG. 1.

FIG. 3 is a sectional view taken along line III-III in FIG. 1.

FIG. 4 is a sectional view corresponding to FIG. 3, in the state where the second housing is placed in a foremost position.

FIG. 5 is a right side view of the electric hammer, in the state where the second housing is placed in the foremost position.

FIG. 6 is a sectional view taken along line VI-VI in FIG. 1.

FIG. 7 is a sectional view corresponding to FIG. 6, in the state where the second housing is placed in the foremost position.

FIG. 8 is a sectional view taken along line III-III in FIG. 1, in the state where the second housing is placed in the rearmost position in an electric hammer of a second embodiment.

FIG. 9 is a sectional view corresponding to FIG. 8, in the state where the second housing is placed in the foremost position.

FIG. 10 is a partial sectional view of an electric hammer of a third embodiment, in the state where a movable unit is placed in a foremost position.

FIG. 11 is a sectional view corresponding to FIG. 10, in the state where the movable unit is placed in a rearmost position.

FIG. 12 is a sectional view of a hammer drill of a fourth embodiment, in the state where a handle is placed in a rearmost position.

FIG. 13 is a sectional view taken along line XIII-XIII in FIG. 12.

FIG. 14 is a sectional view taken along line XIV-XIV in FIG. 13.

FIG. 15 is a sectional view corresponding to FIG. 14, in the state where the handle is placed in a foremost position.

FIG. 16 is a sectional view corresponding to FIG. 13, showing a body housing and the handle when an excessive-rotation state is caused.

### DETAILED DESCRIPTION OF THE EMBODIMENTS

Embodiments are now described with reference to the drawings.

### First Embodiment

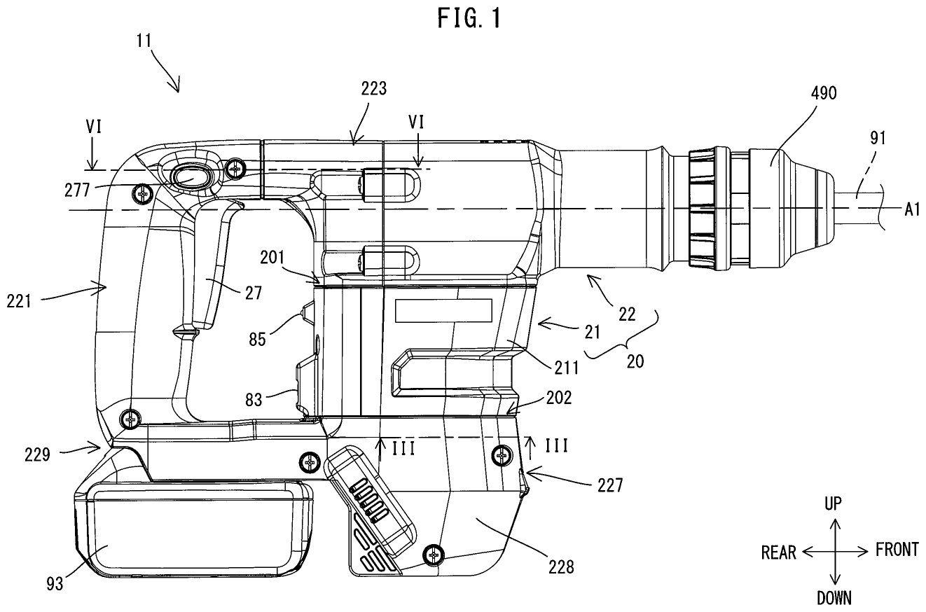

An electric hammer (an electric scraper) 11 according to a first embodiment of the present disclosure is now described as an example with reference to FIGS. 1 to 7. The electric hammer 11 is an example of an impact tool which is configured to linearly drive a tool accessory 91 along a specified driving axis A1. The electric hammer 11 may be used for chipping operation or scraping operation (surface preparation).

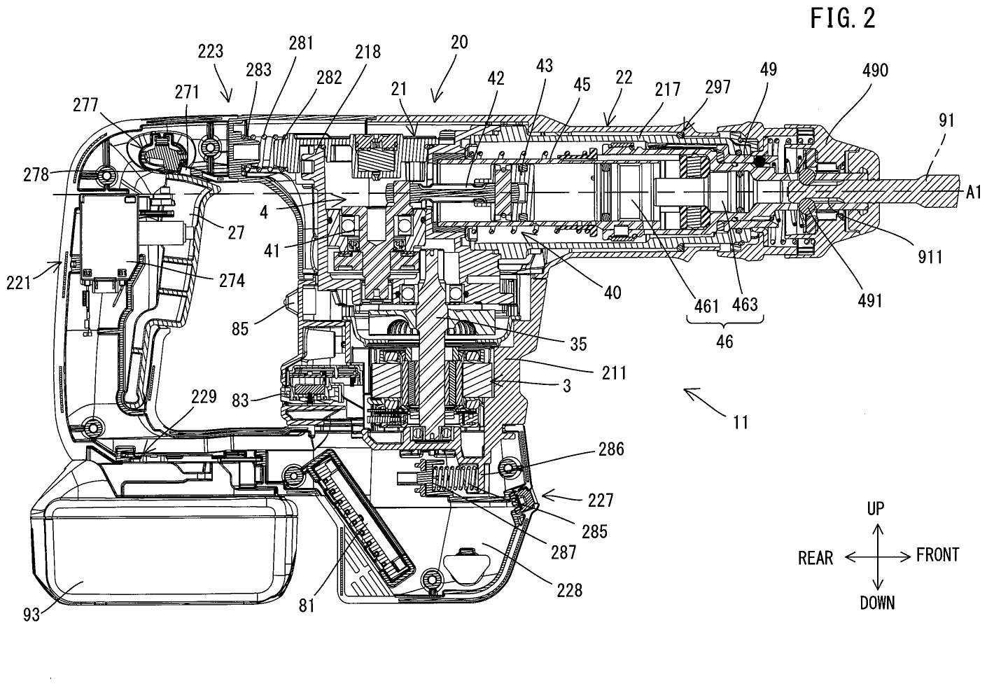

First, the general structure of the electric hammer 11 is described. As shown in FIGS. 1 and 2, an outer shell of the electric hammer 11 is mainly formed by a housing 20. The housing 20 of the present embodiment is configured as a so-called vibration-isolating housing, and includes a first housing 21 and a second housing 22 which is elastically connected to the first housing 21 so as to be movable relative to the first housing 21.

As shown in FIG. 2, the first housing 21 is generally L-shaped as a whole. The first housing 21 includes a motor-housing part 211 that houses the motor 3, and a driving-mechanism-housing part 217 that houses a driving mechanism 4. The driving-mechanism-housing part 217 has an elongate shape and extends in a driving-axis-A1 direction. A tool holder 49 is provided in one end portion of the driving-mechanism-housing part 217 in the driving-axis-A1 direction. The tool holder 49 is configured such that the tool accessory 91 can be removably coupled thereto. The motor-housing part 211 is fixedly connected to the other end portion of the driving-mechanism-housing part 217 in the driving-axis-A1 direction so as to be immovable relative to the driving-mechanism-housing part 217. The motor-housing part 211 is arranged to protrude in a direction crossing the driving axis A1 and away from the driving axis A1. The motor 3 is disposed within the motor-housing part 211 such that a rotation axis of a motor shaft 35 extends in a direction crossing (specifically, orthogonal to) the driving axis A1.

In the following description, for convenience sake, an extending direction of the driving axis A1 of the electric hammer 11 is defined as a front-rear direction of the electric hammer 11. In the front-rear direction, one end side of the electric hammer 11 on which the tool holder 39 is disposed is defined as a front side (also referred to as a front-end-region side) of the electric hammer 11 and the opposite side is defined as a rear side. Further, an extending direction of the rotation axis of the motor shaft 35 is defined as an up-down direction of the electric hammer 11. In the up-down direction, a direction toward which the motor-housing part 211 protrudes from the driving-mechanism-housing part 217 is defined as a downward direction and the opposite direction is defined as an upward direction. Further, a direction orthogonal to the front-rear direction and the up-down direction is defined as a left-right direction.

As shown in FIG. 1, the second housing 22 is a hollow body which is generally U-shaped as a whole. The second housing 22 includes a grip part 221, an upper part 223 and a lower part 227. The grip part 221 is a portion which is configured to be held by a user and which is arranged to extend substantially in the up-down direction crossing the driving axis A1. More specifically, the grip part 221 is arranged apart rearward from the first housing 21 and extends substantially in the up-down direction. A trigger 27 is provided in a front portion of the grip part 221. The trigger 27 is configured to be depressed with a user's finger. The upper part 223 is a portion which is connected to an upper end portion of the grip part 221. In the present embodiment, the upper part 223 extends forward from the upper end portion of the grip part 221 and is configured to cover most of the driving-mechanism-housing part 217 (see FIG. 2) of the first housing 21. The lower part 227 is a portion which is connected to a lower end portion of the grip part 221. In the present embodiment, the lower part 227 extends forward from the lower end portion of the grip part 221 and is arranged on the lower side of the motor-housing part 211. A battery-mounting part 229 is provided in a lower rear end portion of the lower part 227 (specifically, on the lower side of the grip part 221). The electric hammer 11 is configured to be operated with a battery 93 removably mounted to the battery-mounting part 229 as a power source.

With the above-described structure, in the electric hammer 11, the motor-housing part 211 of the first housing 21 is arranged between the upper part 223 and the lower part 227 in the up-down direction and exposed to the outside, and forms an outer surface of the electric hammer 11 together with the second housing 22.

The structure of the electric hammer 11 is now described in detail.

First, a vibration-isolating housing structure of the housing 20 is described. As described above, as for the housing 20, the second housing 22 including the grip part 221 is elastically and movably connected to the first housing 21, so that transmission of vibration from the first housing 21 to the second housing 22 (particularly the grip part 221) is suppressed.

More specifically, as shown in FIG. 2, an elastic member 281 is disposed between a rear end portion of the driving-mechanism-housing part 217 of the first housing 21 and the upper part 223 of the second housing 22. A spring-receiving part 282 is provided to protrude rearward on a rear wall part 218, which defines a rear end portion of the driving-mechanism-housing part 217. A spring-receiving part 283 is provided inside the upper part 223 and protrudes forward facing the spring-receiving part 282. A compression coil spring is employed as the elastic member 281. Front and rear end portions of the elastic member 281 are respectively fitted onto the spring-receiving parts 282 and 283.

An elastic member 285 is disposed between the motor-housing part 211 of the first housing 21 and the lower part 227 of the second housing 22. More specifically, a lower end portion of the motor-housing part 211 is partly disposed within the lower part 227 (specifically, within a controller-housing part 228 to be described later), and has a support wall 286 extending in a direction orthogonal to the driving axis A1. A spring-receiving recess 287 is provided facing a rear surface of the support wall 286 inside the lower part 227. A compression coil spring is also employed as the elastic member 285. Front and rear end portions of the elastic member 285 are respectively supported in contact with the support wall 286 and the spring-receiving recess 287.

Each of the elastic members 281 and 285 is disposed such that its spring force acts in a direction which substantially coincides with the front-rear direction, and biases the first and second housings 21 and 22 away from each other (in respective directions such that the grip part 221 is moved away from the first housing 21) in the driving-axis-A1 direction. Specifically, the first and second housings 21 and 22 are biased forward and rearward, respectively.

The upper part 223 and the lower part 227 are configured to be slidable relative to an upper end portion and a lower end portion of the motor-housing part 211, respectively. More specifically, as shown in FIG. 1, lower end surfaces of right and left walls of the upper part 223 and upper end surfaces of right and left walls of the motor-housing part 211 are configured as sliding surfaces which are slidable in the driving-axis-A1 direction (the front-rear direction) in contact with each other, and together form an upper sliding part 201. Further, upper end surfaces of right and left walls of the lower part 227 and lower end surfaces of right and left walls of the motor-housing part 211 are configured as sliding surfaces which are slidable in the front-rear direction in contact with each other, and together form a lower sliding part 202. Each of the upper and lower sliding parts 201 and 202 functions as a sliding guide for guiding the first and second housings 21 and 22 to move in the front-rear direction relative to each other.

The largest and most dominant vibration caused in the first housing 21 when the tool accessory 91 is driven along the driving axis A1 is a vibration in the front-rear direction. In the present embodiment, the first and second housings 21 and 22 which are connected via the elastic members 281 and 285 move in the front-rear direction relative to each other while being guided by the upper and lower sliding parts 201 and 202. With such a structure, transmission of this vibration in the front-rear direction to the second housing 22 (particularly the grip part 221) can be effectively suppressed.

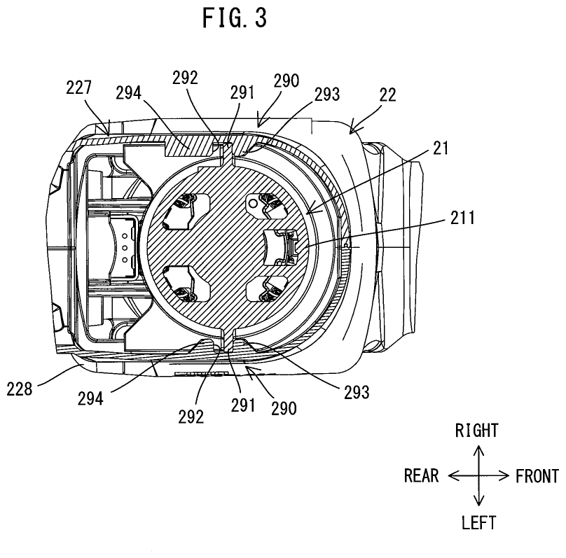

The first and second housings 21 and 22 are provided with a structure for defining a range of the relative movement in the front-rear direction. More specifically, as shown in FIG. 3, a pair of projection pieces 291 are provided on a portion of the motor-housing part 211 which is disposed within the lower part 227. The projection pieces 291 protrude to the right and left toward the right and left walls of the lower part 227. A pair of recesses 292 are formed facing the projection pieces 291 in inner surfaces of the right and left walls of the lower part 227. The projection pieces 291 are respectively disposed within the recesses 292 so as to be movable in the front-rear direction relative to the recesses 292. Wall parts 293 and 294, which respectively define front and rear ends of each of the recesses 292, form a stopper part 290, in cooperation with the projection pieces 291, which defines a rearmost position (also referred to as an initial position) and a foremost position of the second housing 22 relative to the first housing 21.

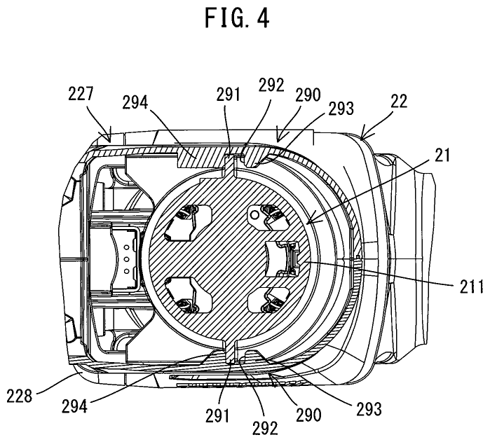

As described above, the first and second housings 21 and 22 are respectively biased forward and rearward by the elastic members 281 and 285. With such a structure, in the initial state, as shown in FIG. 3, the wall parts 293 abut on front ends of the respective projection pieces 291, so that the second housing 22 is prevented from further moving rearward relative to the first housing 21. In other words, the rearmost position of the second housing 22 relative to the first housing 21 is defined as a position where the wall parts 293 abut on the projection pieces 291. When the second housing 22 is moved forward relative to the first housing 21 against biasing force of the elastic members 281 and 285, the second housing 22 is prevented from further moving forward at the point when the wall parts 294 abut on rear ends of the respective projection pieces 291, as shown in FIG. 4. In other words, the foremost position of the second housing 22 relative to the first housing 21 is defined as a position where the wall parts 294 abut on the projection pieces 291.

Although not described in detail and not shown, the rearmost position (initial position) of the second housing 22 relative to the first housing 21 is also defined by a stopper part 297 (see FIG. 2) provided between front end portions of the driving-mechanism-housing part 217 and the upper part 223.

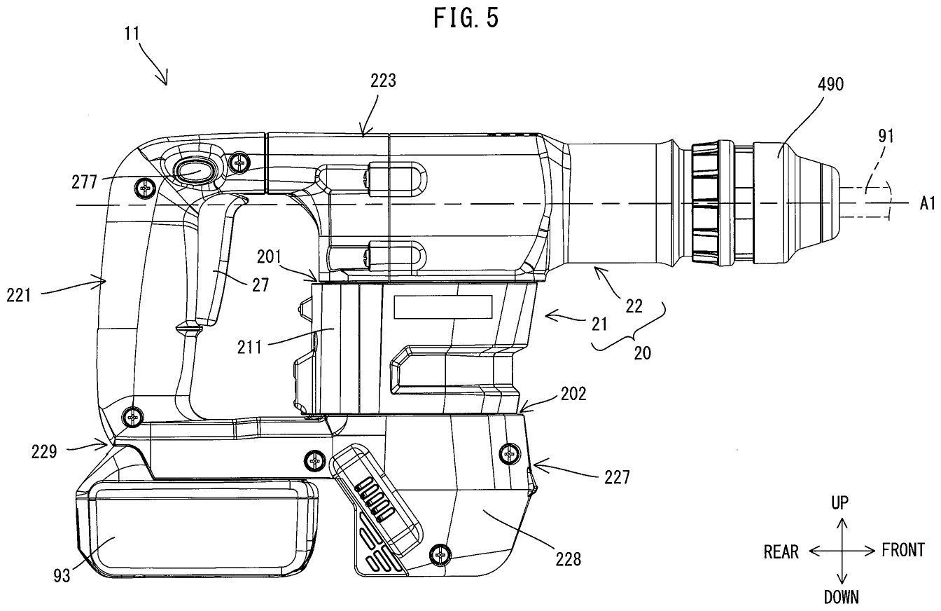

When the second housing 22 is located in the rearmost position, as shown in FIG. 1, a rear end surface of the motor-housing part 211 is substantially flush with a rear end surface of a rear wall part of the upper part 223 which covers the rear end portion of the driving-mechanism-housing part 217. Further, a front end surface of the motor-housing part 211 is substantially flush with a front end surface of the lower part 227. When the second housing 22 is located in the foremost position, as shown in FIG. 5, the motor-housing part 211 is located in a position displaced rearward from the upper part 223 and the lower part 227.

The detailed structure of the first housing 21 and its internal structure are now described.

The motor-housing part 211 and its internal structure are first described. As shown in FIG. 2, the motor-housing part 211 has a bottomed rectangular cylindrical shape having an open upper end. The motor 3, a speed-change dial unit 83 and an LED unit 85 are housed in the motor-housing part 211.

In the present embodiment, a brushless motor is employed as the motor 3. The motor shaft 35 extends in the up-down direction and is rotatably supported at its upper and lower end portions by bearings. A driving gear is provided on the upper end portion of the motor shaft 35 which protrudes into the driving-mechanism-housing part 217. The driving gear is engaged with a driven gear of a crank shaft 41 to be described later.

The speed-change dial unit 83 is disposed behind a body part (a stator and a rotor) of the motor 3 in a lower end portion of the motor-housing part 211. The speed-change dial unit 83 is a device which is configured to receive setting of the rotation speed of the motor 3 according to a user's external operation. Although not shown in detail, the speed-change dial unit 83 includes a dial as an operation member to be turned from the outside of the motor-housing part 211 by a user, a variable resistor for outputting a resistance value corresponding to the turning position of the dial, and a circuit board on which the variable resistor is mounted. The speed-change dial unit 83 is connected to a controller 81 via a wiring (not shown) and configured to output to the controller 81 a signal indicating a resistance value (that is, a set rotation speed) corresponding to a dial turning operation.

The LED unit 85 is disposed in an upper rear end portion of the motor-housing part 211. Although not shown in detail, the LED unit 85 includes an LED (light emitting diode) and a board on which the LED is mounted. The LED unit 85 is electrically connected to the controller 81 via a wiring (not shown). The LED may be lighted according to a control signal from the controller 81.

The driving-mechanism-housing part 217 and its internal structure are described. As shown in FIG. 2, the driving-mechanism-housing part 217 is fixedly and immovably connected to the motor-housing part 211 in a state in which a lower end portion of a rear portion of the driving-mechanism-housing part 217 is disposed within an upper end portion of the motor-housing part 211. Thus, the first housing 21 is formed as a single housing. The driving mechanism 4 is housed in the driving-mechanism-housing part 217. The driving mechanism 4 is configured to perform an operation (hereinafter referred to as a hammering operation) of linearly driving the tool accessory 91 along the driving axis A1 by power of the motor 3.

In the present embodiment, the driving mechanism 4 includes a motion-converting mechanism 40 and a striking mechanism 46. The motion-converting mechanism 40 is configured to convert rotation of the motor shaft 35 into linear motion and to transmit it to the striking mechanism 46. In the present embodiment, a crank mechanism motion-converting mechanism including a crank shaft 41, a connecting rod 42, a piston 43 and a cylinder 45 is adopted as the motion-converting mechanism 40. The striking mechanism 46 is configured to apply a striking force in the driving-axis-A1 direction to the tool accessory 91. In the present embodiment, the striking mechanism 46 includes a striker 461 and an impact bolt 463. The structures of the motion-converting mechanism (crank mechanism) 40 and the striking mechanism 46 are well known and therefore not described in detail here.

When the motor 3 is driven and the piston 43 is moved forward within the cylinder 45, air in an air chamber formed between the piston 43 and the striker 461 is compressed so that the internal pressure increases. Therefore, the striker 461 is pushed forward at high speed by the action of an air spring and collides with the impact bolt 463, thereby transmitting its kinetic energy to the tool accessory 91. A chuck 490 having a well-known structure is mounted to a front end portion of the tool holder 49. The chuck 490 holds the tool accessory 91, via balls 491 fitted in grooves 911 of the tool accessory 91, so as to be slidable in the front-rear direction relative to the first housing 21. The tool accessory 91 is linearly driven along the driving axis A1 by receiving the kinetic energy and strikes a workpiece. On the other hand, when the piston 43 is moved rearward, the air in the air chamber expands so that the internal pressure decreases and the striker 461 is retracted rearward. The tool accessory 91 is moved rearward by being pressed against the workpiece. By repeating the hammering operation by the motion-converting mechanism 40 and the striking mechanism 46 in this manner, the chipping operation or scraping operation (surface preparation) is performed.

The detailed structure of the second housing 22 and its internal structure are now described.

As shown in FIGS. 1 and 2, a rear portion of the upper part 223 has a generally rectangular box-like shape having an open lower end, and covers a rear portion of the driving-mechanism-housing part 217 from above. Further, a front portion of the upper part 223 is cylindrically formed, and covers an outer periphery of a front portion (more specifically, a portion in which the tool holder 49 is housed) of the driving-mechanism-housing part 217.

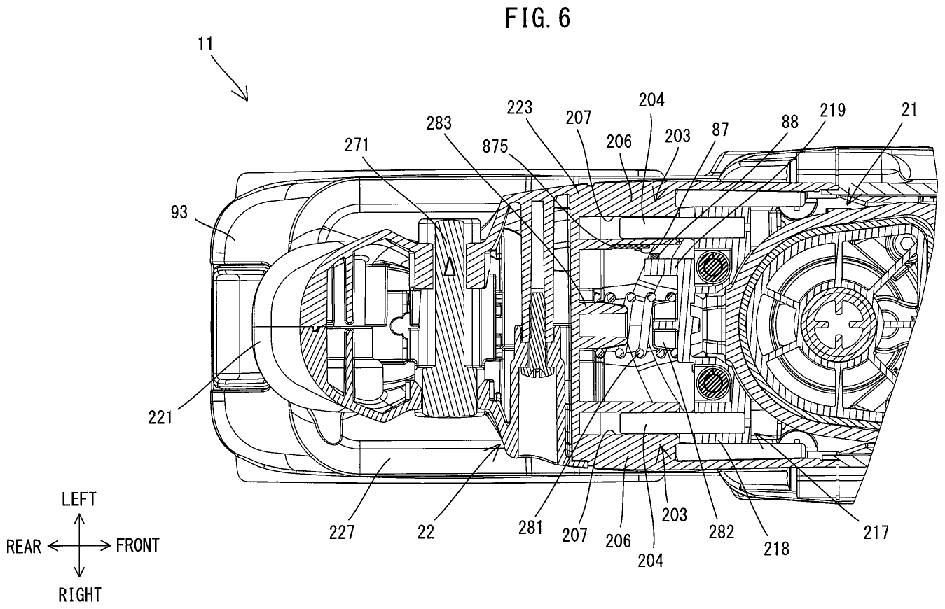

A structure for guiding a movement of the second housing 22 in the front-rear direction relative to the first housing 21 is provided in the upper part 223, in addition to the upper sliding part 201 and the lower sliding part 202 which are described above. Specifically, as shown in FIG. 6, a pair of sliding guides 203 are provided on the right and left sides of the portions (spring-receiving parts 282 and 283) which are elastically connected with each other via the above-described elastic member 281.

Each of the sliding guides 203 includes a pin 204 and a recess 207. The pin 204 protrudes rearward from the rear wall part 218 of the driving-mechanism-housing part 217, with a front end portion of the pin 204 fixed to the rear wall part 218. Portions of right and left walls of the upper part 223 which face the elastically connected portions form a pair of shoulder parts 206 protruding to the left and right, respectively. A front end surface of the shoulder part 206 faces a rear surface of the rear wall part 218. The recess 207 is open to the front end surface of the shoulder part 206 and extends rearward. A rear portion of the pin 204 is inserted into the recess 207 so as to be slidable in the front-rear direction within the recess 207.

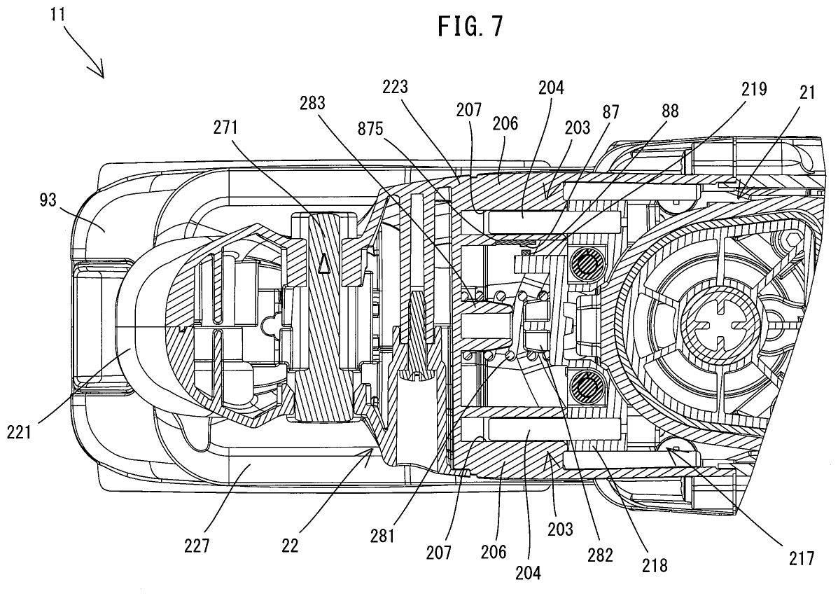

When the second housing 22 is placed in the rearmost position, as shown in FIG. 6, the front end surface of the shoulder part 206 is located apart rearward from the rear surface of the rear wall part 218. When the second housing 22 is placed in the foremost position, as shown in FIG. 7, the front end surface of the shoulder part 206 abuts on the rear surface of the rear wall part 218. In other words, like the wall part 294 and the projection piece 291 (see FIG. 4), the shoulder part 206 and the rear wall part 218 function as a stopper part for defining the foremost position of the second housing 22.

A position sensor 87 for detecting the position of the second housing 22 relative to the first housing 21 is provided in the upper part 223. In the present embodiment, a Hall sensor having a Hall element is employed as the position sensor 87. The position sensor 87 is mounted on a board 875 and fixed to a right surface of the left shoulder part 206 so as to face the portions which are elastically connected via the elastic member 281. A protrusion 219 is provided on the rear wall part 218 of the driving-mechanism-housing part 217. The protrusion 219 is arranged apart rightward from the left shoulder part 206 and extends rearward to face the right surface of the left shoulder part 206. A magnet 88 is fixed to a left surface of the protrusion 219. The position sensor 87 is electrically connected to the controller 81 via a wiring (not shown), and is configured to output a specific signal (hereinafter referred to as an ON signal) to the controller 81 when the magnet 88 is located within a specified detection range.

In the present embodiment, as shown in FIG. 6, when the second housing 22 is located in the rearmost position (initial position) relative to the first housing 21, the magnet 88 is located out of the detection range of the position sensor 87, so that the position sensor 87 does not output an ON signal. When the second housing 22 relatively moves forward from the rearmost position and reaches a specified position, the magnet 88 enters the detection range of the position sensor 87, so that the position sensor 87 starts outputting an ON signal. This specified position (hereinafter referred to as an ON position) is set slightly rearward of the foremost position shown in FIG. 7. The position sensor 87 outputs an ON signal when the second housing 22 is located between the ON position and the foremost position. Detection results of the position sensor 87 are used for drive control of the motor 3 by the controller 81, which will be described in detail later.

As shown in FIG. 2, the trigger 27 is provided in the front portion of the grip part 221. The trigger 27 is held to be rotatable around its lower end portion and movable substantially in the front-rear direction. A switch 274 is disposed within the cylindrical grip part 221. The trigger 27 is normally held in a foremost position (also referred to as an OFF position) by a plunger of the switch 274. At this position, the switch 274 is kept in an OFF state. When the trigger 27 is depressed and turned rearward to a specified position (also referred to as an ON position), the switch 274 is switched to an ON state. The switch 274 is electrically connected to the controller 81 via a wiring (not shown), and outputs a signal indicating an ON state or OFF state to the controller 81.

The electric hammer 11 of the present embodiment has a lock member 277 configured to lock the trigger 27 in the ON position. The structure itself of the lock member 277 is known and therefore briefly described here. The lock member 277 is disposed above the trigger 27 and held by the right and left wall parts of the upper part 223 so as to be movable in the left-right direction. A projection 278 protruding downward is provided on the lock member 277. A projection 271 protruding upward is provided on an upper end portion of the trigger 27.

The lock member 277 is normally held in an unlock position by biasing force of a spring. When the lock member 277 is located in the unlock position, the projection 278 is placed in a position deviated from a moving path of the projection 271, so that the trigger 27 is allowed to turn between the foremost position and the rearmost position. On the other hand, when a user presses the lock member 277 to move the lock member 277 to a lock position after depressing the trigger 27 rearward of the ON position, the projection 278 is placed on the moving path of the projection 271. Therefore, when the user stops the depressing operation of the trigger 27, the projection 278 abuts on a front end of the projection 271 and locks the trigger 27 in the ON position. Further, when the user presses the lock member 277 in the opposite direction, the lock of the trigger 27 is released.

As shown in FIGS. 1 and 2, the lower part 227 is connected to a lower end portion of the grip part 221 and extends forward. A rear portion of the lower part 227 has a smaller height in the up-down direction than a front portion of the lower part 227, and has the battery-mounting part 229 in its lower end portion. In the present embodiment, the battery 93 can be electrically connected to the battery-mounting part 229 when the battery 93 is slid forward from the rear and engaged with guide rails of the battery-mounting part 229. The structures of the battery 93 and the battery-mounting part 229 are well known and therefore their descriptions are omitted here. A front portion of the lower part 227 protrudes downward relative to the rear portion and forms the controller-housing part 228. When the battery 93 is mounted to the battery-mounting part 229, the controller-housing part 228 is located in front of the battery 93, and a lower surface of the controller-housing part 228 is flush with a lower surface of the battery 93.

The controller 81 is housed in a rear end portion of the controller-housing part 228. Although not shown in detail, in the present embodiment, the controller 81 includes a control circuit, a three-phase inverter and a board on which these parts are mounted. The control circuit comprises a microcomputer including a CPU, a ROM, a RAM and a timer. The three-phase inverter includes a three-phase bridge circuit using six semiconductor switching elements. The three-phase inverter is configured to drive the motor 3 by switching each of the switching elements of the three-phase bridge circuit according to the duty ratio indicated by a control signal from the control circuit. In the present embodiment, the controller 81 is configured to control driving of the motor 3 based on the ON/OFF state of the switch 274 and detection results of the position sensor 87, which will be described in detail later.

Operations of the electric hammer 11 (drive control of the motor 3 by the controller 81, in particular) is now described.

In the present embodiment, so-called push-on control is performed by the controller 81 (more specifically, the CPU of the controller 81). The push-on control is a control method in which the motor 3 is not driven in an unloaded state even when the switch 274 is in the ON state, and driving of the motor 3 is started in a loaded state. The unloaded state is shifted to the loaded state when the tool accessory 91 is pressed against the workpiece and pushed rearward relative to the first housing 21. A user presses the tool accessory 91 against the workpiece while holding the grip part 221, so that the second housing 22 moves forward relative to the first housing 21 when the tool accessory 91 is pushed rearward. Therefore, in the present embodiment, the controller 81 is configured to start driving of the motor 3 when the position sensor 87 detects a forward relative movement (specifically, a relative movement to the ON position) of the second housing 22 as the rearward push of the tool accessory 91.

In the unloaded state in which the tool accessory 91 is not pressed against the workpiece, the second housing 22 is placed in the rearmost position by the biasing force of the elastic members 281 and 285 (see FIGS. 2 and 6). At this time, since the magnet 88 is located out of the detection range of the position sensor 87, the output from the position sensor 87 to the controller 81 is off. When the user presses the tool accessory 91 against the workpiece while holding the grip part 221, the tool accessory 91 is pushed rearward and the second housing 22 moves forward relative to the first housing 21 while compressing the elastic members 281 and 285. The controller 81 does not start driving of the motor 3, regardless of the ON/OFF state of the switch 274, while the second housing 22 does not reach the ON position and the output from the position sensor 87 is off.

When the controller 81 recognizes an ON signal outputted from the switch 274 while the output from the position sensor 87 is off, the controller 81 outputs a control signal to the LED unit 85 and lights the LED. In the push-on control, in the unloaded state, the motor 3 is not driven even when the trigger 27 is depressed, so that the user may be confused. Therefore, in order to prevent the user's confusion, it is indicated by lighting of the LED that the switch 274 itself for energizing the motor 3 is in the ON state and driving of the motor 3 can be started if the tool accessory 91 is sufficiently pushed rearward. In other words, lighting of the LED indicates that the electric hammer 11 is in a standby state.

When the second housing 22 reaches the ON position, the position sensor 87 starts outputting an ON signal. The controller 81 recognizes a change from OFF to ON of the output from the position sensor 87 as a relative movement of the second housing 22 to the ON position. At this time, if the switch 274 is in the ON state, the controller 81 starts driving of the motor 3. In other words, the controller 81 starts driving of the motor 3 in response to detection of a rearward push of the tool accessory 91 by the position sensor 87, only when the switch 274 is in the ON state. If the controller 81 controls driving of the motor 3 only in response to detection of the push of the tool accessory 91, the motor 3 may be driven when the tool accessory 91 is pushed for some reason when such is not intended by a user. Such a possibility can be reduced by adopting the described-above control.

The controller 81 drives the motor 3 by setting the duty ratio corresponding to the rotation speed (set speed) set via the speed-change dial unit 83 and outputting a control signal to the three-phase inverter. The controller 81 may immediately or gradually increase the rotation speed of the motor 3 up to the set speed. When the motor 3 is driven, the driving mechanism 4 is driven and the hammering operation is performed.

The controller 81 monitors the duration of the OFF state using the timer when recognizing a change from ON to OFF of the output from the position sensor 87 (that is, a rearward movement of the second housing 22 from the ON position) while the switch 274 is in the ON state. Then, the controller 81 stops driving of the motor 3 only when the OFF state continues for a specified time. This serves to reliably distinguish between a temporary change to the OFF state, which may be caused due to vibration of the first housing 21 by the chipping operation, and a change from the loaded state to the unloaded state.

Specifically, the second housing 22 may be caused to reciprocally move in the front-rear direction relative to the first housing 21 by vibration of the first housing 21 in the front-rear direction. In this case, the output from the position sensor 87 may be switched between ON and OFF at a short cycle. However, when the operation of pressing the tool accessory 91 against the workpiece is released and the loaded state is shifted to the unloaded state, the OFF state continues for a specified time after the output from the position sensor 87 is switched from ON to OFF. Therefore, in the present embodiment, by adopting the above-described control, release of the push of the tool accessory 91 corresponding to release of the operation of pressing the tool accessory 91 against the workpiece by a user can be properly determined and driving of the motor 3 can be stopped accordingly.

When the depressing operation of the trigger 27 is stopped during driving of the motor 3 and the switch 274 is turned off, the controller 81 stops driving of the motor 3. The electric hammer 11 of the present embodiment has the lock member 277 capable of locking the trigger 27 in the ON position. Therefore, the user can eliminate the trouble of continuing the depressing operation of the trigger 27 by locking the trigger 27 in the ON position.

As described above, the electric hammer 11 of the present embodiment is configured to drive the motor 3, using the battery 93 as a power source. The controller 81 is configured to perform the push-on control of starting driving of the motor 3 in response to detection of a push of the tool accessory 91, that is, detection of a shift from the unloaded state to the loaded state by the position sensor 87. Therefore, electric power is not consumed in the unloaded state. Therefore, further power saving can be realized compared with a case in which the motor 3 is driven at low speed in the unloaded state and then driven at high speed in response to the shift to the loaded state.

In the electric hammer 11, the second housing 22 having the grip part 221 is elastically and movably connected to the first housing 21 which houses the motor 3 and the driving mechanism 4. The position sensor 87 is configured to detect a forward movement of the second housing 22 relative to the first housing 21 as a rearward push of the tool accessory 91. When a user presses the tool accessory 91 against the workpiece while holding the grip part 221 of the electric hammer 11, the second housing 22 is moved forward relative to the first housing 21 along with the push of the tool accessory 91. Therefore, the position sensor 87 can properly detect the push of the tool accessory 91. Further, vibration may be caused in the first housing 21 when the tool accessory 91 is driven, but the elastic members 281 and 285 can suppress transmission of the vibration to the second housing 22 (particularly the grip part 221).

In the present embodiment, the position sensor 87 is disposed not in the first housing 21 but in the second housing 22. Therefore, the position sensor 87, which is a precision apparatus having electronic components, can be protected from vibration.

### Second Embodiment

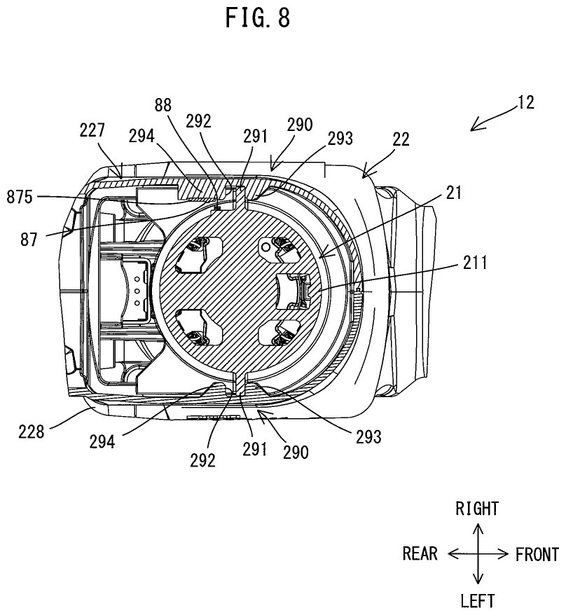

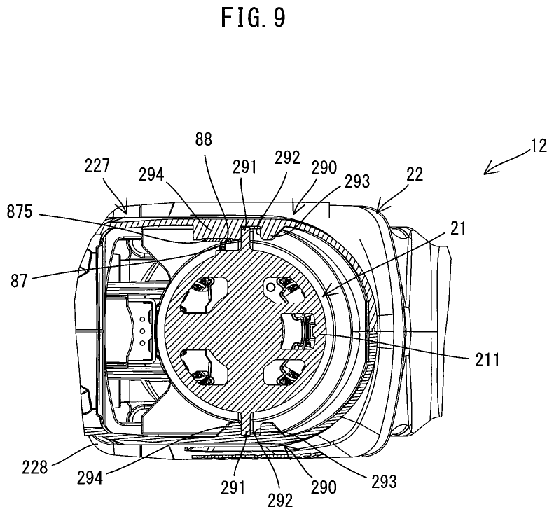

An electric hammer 12 according to a second embodiment of the present disclosure is now described with reference to FIGS. 8 and 9. The electric hammer 12 of the present embodiment has substantially the same structure as the electric hammer 11 of the first embodiment, except that the arrangement position of the position sensor 87 is different from that in the first embodiment. Therefore, the same structure is not shown and not described and only the different structure is described with reference to the drawings. The same is true for the third and following embodiments.

As shown in FIG. 8, in the electric hammer 12 of the present embodiment, the position sensor 87 is provided in the lower part 227 in place of the upper part 223. Further, the magnet 88 is provided in the motor-housing part 211 in place of the driving-mechanism-housing part 217. More specifically, the position sensor 87 is mounted on the board 875 and fixed to the wall part 294 forming the right stopper part 290 so as to face the motor-housing part 211. The magnet 88 is fixed to a right surface of a lower end portion of the motor-housing part 211.

In the present embodiment, like in the first embodiment, the position sensor 87 also detects the position of the second housing 22 relative to the first housing 21. The method of detecting the relative position of the second housing 22 by the position sensor 87 and the method of controlling driving of the motor 3 are essentially the same as in the first embodiment and therefore briefly described.

As shown in FIG. 8, when the second housing 22 is located in the rearmost position (initial position) relative to the first housing 21, the magnet 88 is located out of the detection range of the position sensor 87 and thus the position sensor 87 does not output an ON signal. When the second housing 22 relatively moves forward from the rearmost position and reaches the ON position, the magnet 88 enters the detection range of the position sensor 87 and the position sensor 87 starts outputting an ON signal. Further, the ON position is set slightly rearward of the foremost position shown in FIG. 9 and the position sensor 87 outputs an ON signal when the second housing 22 is located between the ON position and the foremost position. The controller 81 (see FIG. 2) performs the above-described push-on control based on the detection results of the position sensor 87.

As described above, in the present embodiment, even though the position sensor 87 is placed in a different position from that in the first embodiment within the second housing 22, like in the first embodiment, the position sensor 87 can properly detect a rearward movement of the second housing 22 relative to the first housing 21. Therefore, the controller 81 performs proper push-on control so that power saving can be realized.

### Third Embodiment

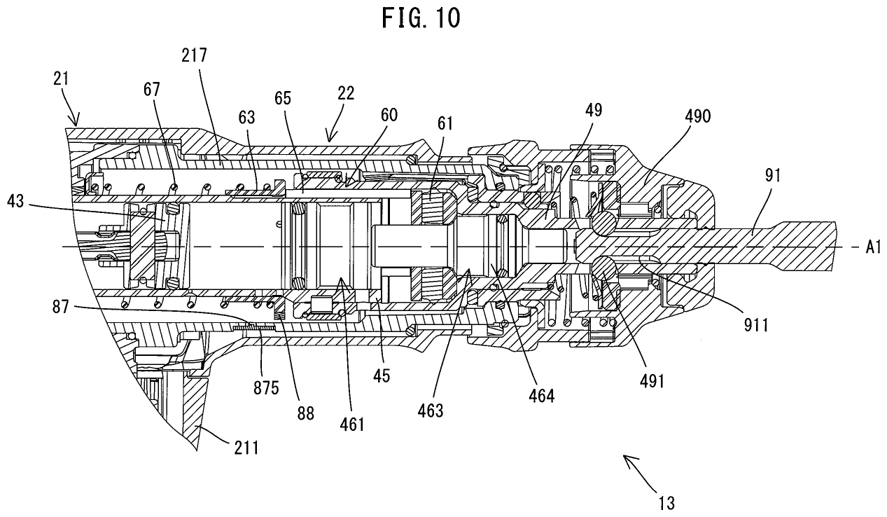

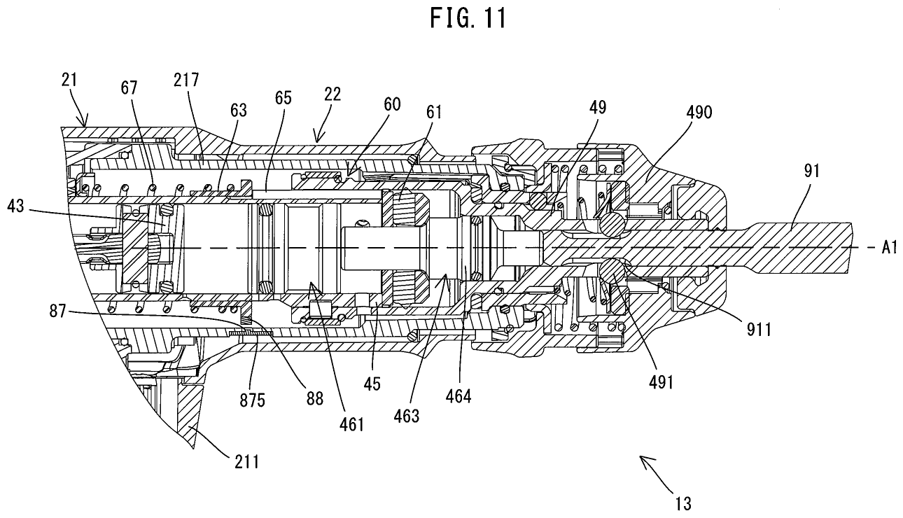

An electric hammer 13 according to a third embodiment of the present disclosure is now described with reference to FIGS. 10 and 11. The electric hammer 13 of the present embodiment has substantially the same structure as the electric hammer 11 of the first embodiment, except that the arrangement position of the position sensor 87 and an object to be detected by the position sensor 87 are different from those in the first embodiment.

As shown in FIG. 10, in the electric hammer 13 of the present embodiment, the position sensor 87 is fixed to the first housing 21 (the driving-mechanism-housing part 217) and detects a rearward movement of a movable unit 60 relative to the first housing 21 as a rearward push of the tool accessory 91.

The movable unit 60 is now described. The movable unit 60 is disposed between the cylinder 45 which is fixedly held by the first housing 21, and the tool holder 49. Further, the movable unit 60 is configured to move rearward together with the tool accessory 91 by interlocking with a rearward push of the tool accessory 91. The movable unit 60 includes a receiving part 61, a sleeve 63 and a pin 65. The receiving part 61 includes an annular elastic element and washers, and is slidably disposed within the tool holder 49. The receiving part 61 is configured to abut on a rear end of a larger diameter part 464 of the impact bolt 463 to thereby restrict a rearward movement of the impact bolt 463. The sleeve 63 is a cylindrical member having a flange on its front end, and is disposed to be slidable along an outer peripheral surface of the cylinder 45 in the front-rear direction. The pin 65 is disposed within a groove formed in the outer peripheral surface of the cylinder 45 and extends in the front-rear direction. The pin 65 is in contact with a rear end of the receiving part 61 and a front end of the flange of the sleeve 63.

An elastic member 67 is disposed between the movable unit 60 and a wall part of the first housing 21 in the front-rear direction. The elastic member 67 is a compression coil spring. The elastic member 67 is arranged to extend in the front-rear direction and in contact with a rear end of the flange of the sleeve 63. The elastic member 67 biases the whole movable unit 60 (the sleeve 63, the pin 65 and the receiving part 61) forward. With such a structure, in the unloaded state in which the tool accessory 91 is not pressed against the workpiece, as shown in FIG. 10, the impact bolt 463 is biased forward via the receiving part 61 and held in a foremost position where a front end of the large diameter part 464 abuts on a shoulder part of the tool holder 49. The movable unit 60 is also held in a foremost position (initial position) within a movable range by biasing force of the elastic member 67.

As shown in FIG. 11, when the tool accessory 91 is pressed against the workpiece and pushed into the first housing 21, a rear end of the tool accessory 91 abuts on the impact bolt 463 to press the impact bolt 463 rearward. Thus, the movable unit 60 moves rearward relative to the first housing 21 against the biasing force of the elastic member 67. Further, the rearmost positions of the impact bolt 463 and the movable unit 60 are defined as a position where the rear end of the receiving part 61 abuts on a front end of the cylinder 45.

The position sensor 87 is mounted on the board 875 and fixed to a lower end portion of the driving-mechanism-housing part 217 so as to face the cylinder 45. The magnet 88 is fixed to a lower end of the flange of the sleeve 63. The position sensor 87 is electrically connected to the controller 81 (see FIG. 2) via a wiring (not shown) and configured to output a specific signal (ON signal) to the controller 81 when the magnet 88 is located within a specified detection range.

In the present embodiment, as shown in FIG. 10, the magnet 88 is located out of the detection range of the position sensor 87 when the movable unit 60 is located in the foremost position (initial position) relative to the first housing 21, so that the position sensor 87 does not output an ON signal. When the movable unit 60 relatively moves rearward from the foremost position and reaches a specified position, the magnet 88 enters the detection range of the position sensor 87, so that the position sensor 87 starts outputting an ON signal. Further, this specified position (hereinafter referred to as an ON position) is set slightly forward of the rearmost position shown in FIG. 11 and the position sensor 87 outputs an ON signal when the movable unit 60 is located between the ON position and the rearmost position.

In the present embodiment, the controller 81 is configured to start driving of the motor 3 when the position sensor 87 detects a relative rearward movement of the movable unit 60 (specifically, a relative movement to the ON position) as a rearward push of the tool accessory 91. The method of controlling driving of the motor 3 is essentially the same as that in the first embodiment. Specifically, the controller 81 does not start driving of the motor 3 regardless of the ON/OFF state of the switch 274 when the output from the position sensor 87 is off. Further, the controller 81 recognizes a change from OFF to ON of the output of the position sensor 87 as the relative movement of the movable unit 60 to the ON position and starts driving of the motor 3 if the switch 274 is in the ON state.

As describe above, the electric hammer 13 of the present embodiment includes the movable unit 60 which is configured to move rearward relative to the first housing 21 together with the tool accessory 91 by interlocking with the rearward push of the tool accessory 91. Thus, the position sensor 87 can properly detect the rearward movement of the movable unit 60 relative to the first housing 21 as the rearward push of the tool accessory 91. Therefore, the controller 81 can perform proper push-on control so that power saving can be realized.

### Fourth Embodiment

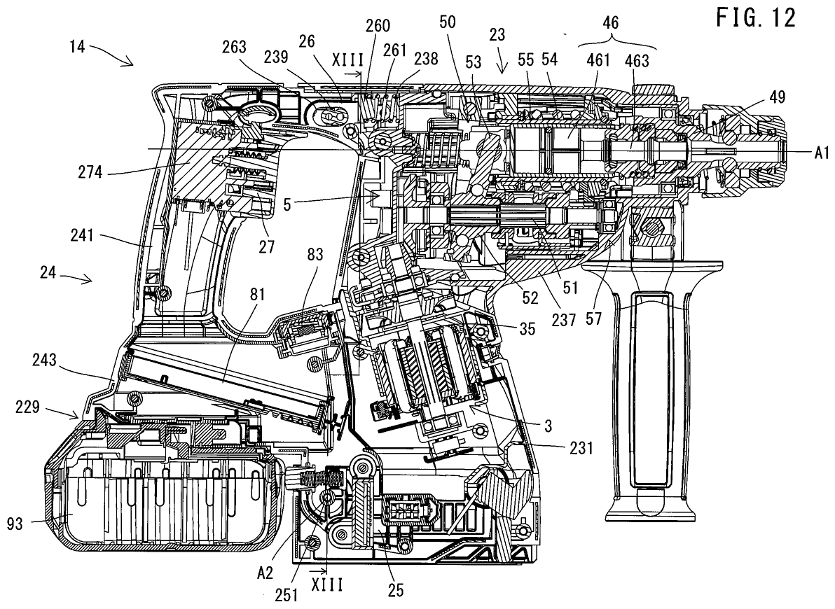

A hammer drill 14 according to a fourth embodiment of the present disclosure is now described with reference to FIGS. 12 to 15. The hammer drill 14 of the present embodiment is a power tool capable of performing a drilling operation of rotationally driving the tool accessory 91 around the driving axis A1, in addition to the hammering operation.

As shown in FIG. 12, an outer shell of the hammer drill 14 mainly includes a body housing 23 and a handle 24. In the present embodiment, the handle 24 is configured as a so-called vibration-isolating handle and elastically connected to the body housing 23 so as to be movable relative to the body housing 23.

The structure of the body housing 23 and its internal structure are first described.

As shown in FIG. 12, the body housing 23 is generally L-shaped as a whole, and includes a motor-housing part 231 that houses the motor 3, and a driving-mechanism-housing part 237 that houses a driving mechanism 5. The driving-mechanism-housing part 237 has an elongate shape extending in the driving-axis-A1 direction (front-rear direction). The tool holder 49 is provided in a front end portion of the driving-mechanism-housing part 237. The motor-housing part 231 is fixedly connected to a rear end portion of the driving-mechanism-housing part 237 so as to be immovable relative to the driving-mechanism-housing part 237. The motor-housing part 231 is arranged to protrude in a downward direction crossing the driving axis A1. The motor 3 is disposed within the motor-housing part 231 such that a rotation axis of the motor shaft 35 extends in a direction crossing (specifically, oblique to) the driving axis A1.

The driving mechanism 5 includes a motion-converting mechanism 50, the striking mechanism 46 and a rotation-transmitting mechanism 57. In the present embodiment, the motion-converting mechanism 50 is configured as a so-called swing-type motion-converting mechanism, and includes an intermediate shaft 51, a rotary body 52, a swinging member 53 and a piston cylinder 55. The rotation-transmitting mechanism 57 is configured to transmit rotation of the motor shaft 35 to the tool holder 49. In the present embodiment, the rotation-transmitting mechanism 57 is configured as a gear speed-reducing mechanism including a plurality of gears, and configured to appropriately reduce the rotation speed of the motor 3 and then transmit the rotation to the tool holder 49. The structures of the motion-converting mechanism 50 and the rotation-transmitting mechanism 57 are well known and therefore not described in detail here.

The hammer drill 14 is configured such that any one of three operation modes of a hammer-drill mode, a hammer mode and a drill mode is selectable, by operating a mode-switching dial (not shown) provided on a left-side portion of the driving-mechanism-housing part 237. In the hammer-drill mode, the motion-converting mechanism 50 and the rotation-transmitting mechanism 57 are driven, so that the hammering operation and the drilling operation are performed. In the hammer mode, power transmission in the rotation-transmitting mechanism 57 is interrupted and only the motion-converting mechanism 50 is driven, so that only the hammering operation is performed. In the drill mode, power transmission in the motion-converting mechanism 50 is interrupted and only the rotation-transmitting mechanism 57 is driven, so that only the drilling operation is performed. A mode-switching mechanism is provided within the body housing 23 (specifically, within the driving-mechanism-housing part 237). The mode-switching mechanism is connected to the mode-switching dial and configured to switch the motion-converting mechanism 50 and the rotation-transmitting mechanism 57 between a transmission state and an interruption state according to the operation mode selected with the mode-switching dial. The structure of such a mode-switching mechanism is well known and therefore not described in detail here and not shown.

The structure of the handle 24 and its internal structure are now described.

As shown in FIG. 12, the handle 24 is generally C-shaped in a side view as a whole. Both end portions of the handle 24 are connected to the body housing 23. The handle 24 includes a grip part 241, a controller-housing part 243, a lower connection part 25 and an upper connection part 26.

The grip part 241 is arranged to be spaced rearward apart from the body housing 23 and extends substantially in the up-down direction, crossing the driving axis A1. The trigger 27 is provided in a front portion of an upper end portion of the grip part 241. The switch 274 is housed within the grip part 241. The controller-housing part 243 is connected to a lower end of the grip part 241 and disposed on the lower side of the grip part 241. The controller-housing part 243 has a rectangular box-like shape and extends forward from the grip part 241. The controller-housing part 243 houses the controller 81 and the speed-change dial unit 83. A lower end portion (a portion below the controller 81) of the controller-housing part 243 is configured as the battery-mounting part 229.

The lower connection part 25 is a portion of the handle 24 which is connected to a front end portion of the controller-housing part 243 and extends substantially in a downward direction. The upper connection part 26 is a portion of the handle 24 which is connected to an upper end portion of the grip part 241 and extends forward. In the present embodiment, the handle 24 is connected to the body housing 23 via the lower connection part 25 and the upper connection part 26 so as to be movable relative to the body housing 23. Connecting structures between the lower and upper connection parts 25 and 26 and the body housing 23 are now described in detail.

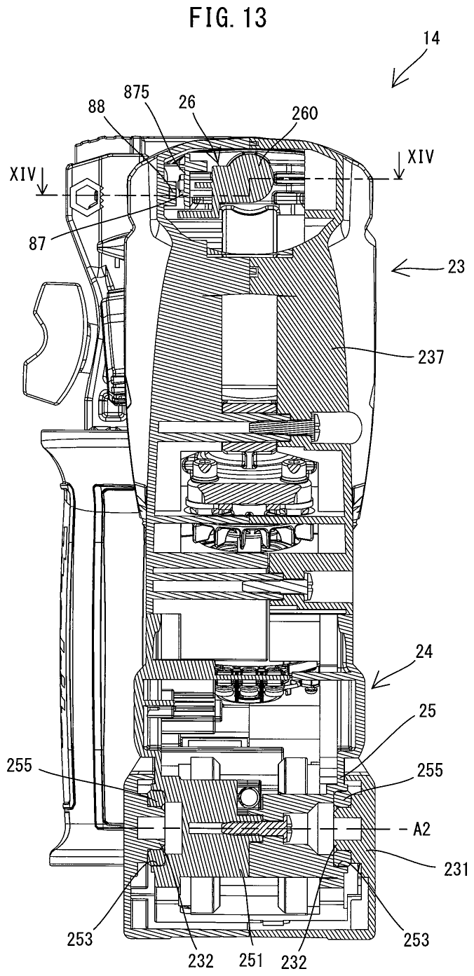

As shown in FIGS. 12 and 13, the lower connection part 25 is a portion which is arranged to protrude into a lower rear end portion of the motor-housing part 231. The lower connection part 25 is also connected to a lower rear end portion (specifically, the motor-housing part 231) of the body housing 23 so as to be rotatable relative to the body housing 23 around a rotation axis A2, which extends in the left-right direction. The motor 3 is disposed in an upper portion of the motor-housing part 231, but a free space exists below the motor 3. Therefore, in the present embodiment, the lower connection part 25 is arranged utilizing this free space to connect the handle 24 and the motor-housing part 231.

As shown in FIG. 13, the lower connection part 25 has a shaft part 251 which extends in the left-right direction between right and left wall parts of the lower connection part 25 such that a center axis of the shaft part 251 coincides with the rotation axis A2. Recesses 253 are respectively provided in positions corresponding to both ends of the shaft part 251 in outer surfaces of the right and left wall parts of the lower connection part 25. Each of the recesses 253 is configured as a recess having a circular section centering the rotation axis A2. An annular elastic member 255 is fitted in each of the recesses 253.

Protruding parts 232 are respectively provided to protrude to the right and left from inner surfaces of left and right wall parts of the motor-housing part 231. Each of the protruding parts 232 has a generally cylindrical shape and arranged such that its axis coincides with a straight line extending in the left-right direction. Each of protruding end portions of the protruding parts 232 is fitted in the elastic member 255 within the recess 253, so that the lower rear end portion of the motor-housing part 231 is connected to the lower connection part 25 via the elastic member 255. By such concavo-convex engagement via the elastic member 255, the lower connection part 25 is connected to the motor-housing part 231 so as to be rotatable around the rotation axis A2 relative to the motor-housing part 231. Further, the lower connection part 25 is held to be movable in any direction relative to the motor-housing part 231 by the elastic member 255.

As shown in FIG. 12, the upper connection part 26 is arranged to protrude into a rear end portion of the driving-mechanism-housing part 237 and movably connected to an upper rear end portion (specifically, the driving-mechanism-housing part 237) of the body housing 23 via an elastic member 261. In the present embodiment, a compression coil spring is employed as the elastic member 261. A rear end portion of the elastic member 261 is fitted onto a spring-receiving part 260 provided in a front end portion of the upper connection part 26. A front end of the elastic member 261 abuts on a rear surface of a support wall 238 disposed within a rear end portion of the driving-mechanism-housing part 237. Specifically, the elastic member 261 is arranged such that spring force acts in a direction which substantially coincides with the front-rear direction, which is a direction of dominant vibration caused during the hammering operation.

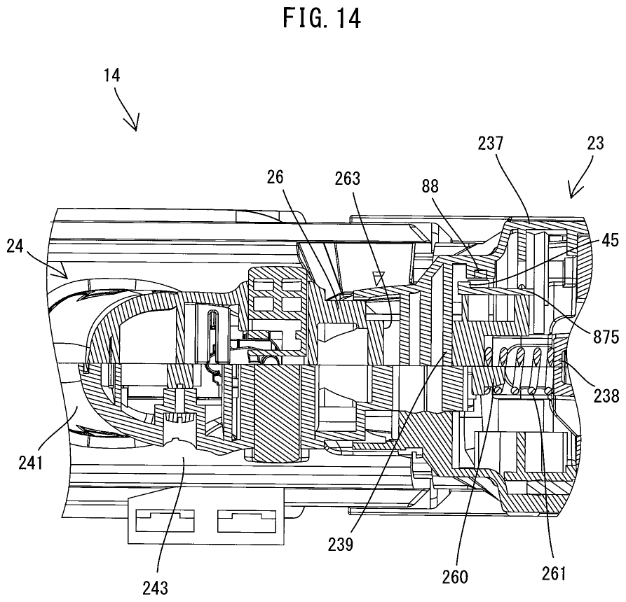

Further, the upper connection part 26 has an elongate hole 263 formed on the rear side of the spring-receiving part 260. The elongate hole 263 is a through hole extending through the upper connection part 26 in the left-right direction and formed longer in the front-rear direction than in the up-down direction. As shown in FIGS. 12 and 14, a stopper part 239 is provided on the inside of the driving-mechanism-housing part 237. The stopper part 239 is a columnar portion extending in the left-right direction between right and left wall parts of the driving-mechanism-housing part 237 and inserted through the elongate hole 263.

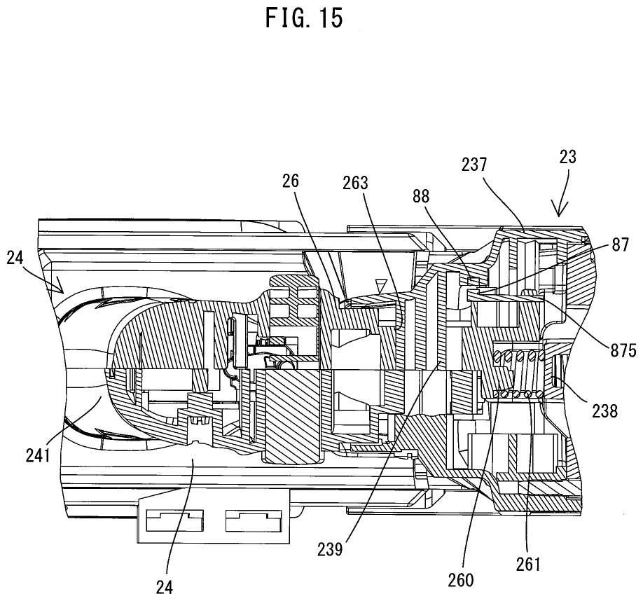

In the unloaded state, the upper connection part 26 is biased in a direction (rearward) away from the body housing 23 in the front-rear direction by the elastic member 261, and held in a position where the stopper part 239 abuts on a front end of the elongate hole 263 and thereby restricts a rearward movement of the upper connection part 26. This position of the upper connection part 26 (the handle 24) relative to the body housing 23 is referred to as a rearmost position. When the handle 24 is relatively turned forward around the rotation axis A2, the stopper part 239 of the body housing 23 relatively moves rearward apart from the front end of the elongate hole 263 within the elongate hole 263 of the upper connection part 26. Therefore, the handle 24 is allowed to move relative to the body housing 23 within a movable range of the stopper part 239 in the elongate hole 263. Particularly, as shown in FIG. 15, in the front-rear direction, the handle 24 is allowed to move forward against the biasing force of the elastic member 261, up to a position where the stopper part 239 abuts on a rear end of the elongate hole 263 and thereby prevents a further forward movement of the handle 24. This position of the handle 24 relative to the body housing 23 is referred to as a foremost position.

As shown in FIGS. 13 and 14, the position sensor 87 for detecting the position of the handle 24 relative to the body housing 23 is provided in the upper connection part 26. The position sensor 87 is mounted on the board 875 and fixed to a left front end portion of the upper connection part 26 so as to face a left wall part of the body housing 23 (the driving-mechanism-housing part 237). Further, the magnet 88 is fixed to an inner surface of the left wall part of the body housing 23.

In the present embodiment, the position sensor 87 is configured to detect not only a push of the tool accessory 91 (that is, a forward relative movement of the handle 24), but also a so-called excessive-rotation state. The excessive-rotation state refers to a state in which the body housing 23 excessively rotates around the driving axis A1, for example, due to locking of the tool accessory 91 to the workpiece during the drilling operation in which the tool accessory 91 is rotationally driven. In the present embodiment, for example, a sensor having a plurality of Hall elements may be employed as the position sensor 87. In this case, the position sensor 87 is capable of detecting an amount and direction of a movement of the magnet 88 based on magnetic flux density measured in each of the Hall elements.

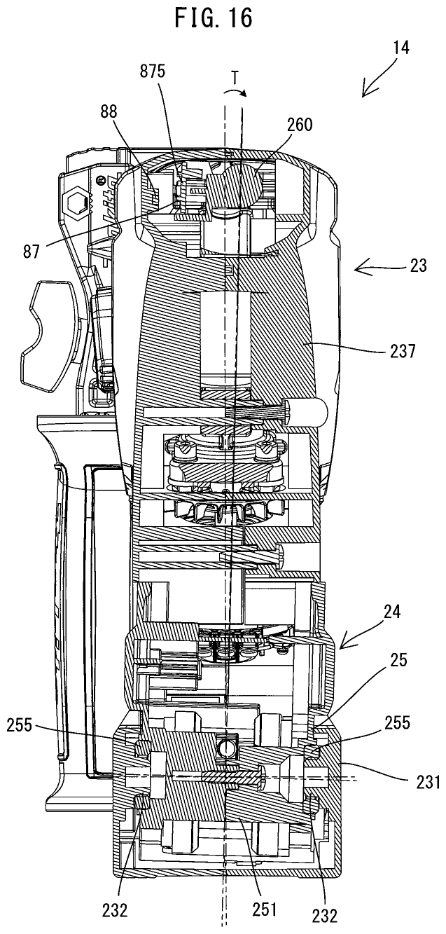

In the present embodiment, by provision of the above-described connecting structures of the upper and lower connection parts 25 and 26, the handle 24 can be moved in any direction relative to the body housing 23 within the movable range of the stopper part 239 in the elongate hole 263. When the body housing 23 rotates around the driving axis A1 with the grip part 241 held by a user, as shown in FIG. 16, the handle 24 moves in a twisting direction (for example, a direction shown by arrow T in FIG. 16) around the shaft part 251 relative to the body housing 23 due to elastic deformation of the elastic member 255. This relative movement can be regarded as a relative movement on a plane (an imaginary plane) which is orthogonal to the driving axis A1. Therefore, the position sensor 87 detects this relative movement in the form of a relative movement of the magnet 88 on a plane which passes through the position sensor 87 and which is orthogonal to the driving axis A1 (in other words, a relative movement in a direction other than the front-rear direction). Further, the position sensor 87 detects a push of the tool accessory 91, that is, a forward relative movement of the handle 24, in the form of a rearward movement of the magnet 88.

The position sensor 87 is disposed in the upper connection part 26 which is far apart from the rotation axis A2 (the shaft part 251). In this position, the swing width of the handle 24 (the upper connection part 26) relative to the body housing 23 (that is, an amount of a movement of the handle 24 relative to the body housing 23) is relatively large, compared with the swing width in the vicinity of the rotation axis A2. Therefore, the position sensor 87 can accurately detect a push of the tool accessory 91 and an excessive-rotation state.

The drive control of the motor 3 in the present embodiment is now described.

In the present embodiment, the controller 81 is configured to perform a push-on control similar to that in the first embodiment. Specifically, the controller 81 does not start driving of the motor 3 regardless of the ON/OFF state of the switch 274, as long as the output from the position sensor 87 is off. Further, when the output from the position sensor 87 is changed from OFF to ON, the controller 81 starts driving of the motor 3 if the switch 274 is in the ON state. Furthermore, when the output from the position sensor 87 is turned off after the position sensor 87 detects a forward movement of the magnet 88 within the detection range, the controller 81 stops driving of the motor 3 only if the OFF state continues for a specified time. Like in the first embodiment, this is to reliably distinguish between a temporary change to the OFF state which is caused due to vibration of the first housing 21 by the chipping operation and a change to the unloaded state which is caused by release of push of the tool accessory 91.

Further, the controller 81 is configured to stop driving of the motor 3 when an excessive rotation state is detected by the position sensor 87 during driving of the motor 3. More specifically, the controller 81 stops driving of the motor 3 when the output from the position sensor 87 is turned off (in other words, when the amount of the relative movement of the magnet 88 on the plane passing through the position sensor 87 and orthogonal to the driving axis A1 exceeds a specified amount) after the position sensor 87 detects a movement of the magnet 88 in a direction (for example, substantially in the left direction in the case shown in FIG. 16) other than the front-rear direction within the detection range. At this time, it may be preferred that the controller 81 not only stops energization to the motor 3 but also electrically brakes the motor 3 in order to prevent the motor shaft 35 from continuing to rotate by inertia of the rotor.

In the present embodiment, the controller 81 is configured not to restart driving of the motor 3 until another (a second) push of the tool accessory 91 is detected, in a case where an excessive-rotation state is detected by the position sensor 87 and driving of the motor 3 is stopped. Specifically, the controller 81 restarts driving of the motor 3 only when a release of the push of the tool accessory 91 and the second push of the tool accessory 91 are detected after the excessive-rotation state is detected as described above. Thus, a non-driven state of the motor is maintained until the excessive-rotation state is reliably resolved.

As described above, in the hammer drill 14 of the present embodiment, the handle 24 having the grip part 241 is elastically and movably connected to the body housing 23 which houses the motor 3 and the driving mechanism 5. The position sensor 87 which is disposed in the handle 24 can properly detect a forward movement of the handle 24 relative to the body housing 23 as a rearward push of the tool accessory 91. Therefore, the controller 81 can perform proper push-on control so that power saving can be realized.

Further, in the present embodiment, the hammer drill 14 is configured to be capable of performing the hammering operation and the drilling operation. When the tool accessory 91 is rotationally driven by the drilling operation, an excessive-rotation state may be caused. In the present embodiment, the position sensor 87 is capable of detecting, as the excessive-rotation state, a movement of the handle 24 on a plane orthogonal to the driving axis A1 relative to the body housing 23. The controller 81 stops driving of the motor 3 when the excessive-rotation state is detected, thereby preventing the body housing 23 from further rotating. Particularly, in the present embodiment, the position sensor 87 is configured to detect a relative movement of the handle 24 in the front-rear direction, as well as a relative movement of the handle 24 on the plane orthogonal to the driving axis A1. Thus, detection of a push of the tool accessory 91 and detection of an excessive-rotation state can be realized without increase in the number of components (parts).

In the above-described embodiment, the electric hammers 11 to 13 and the hammer drill 14 are described as examples of an impact tool which is configured to linearly drive the tool accessory 91, but the present disclosure may be applied to other impact tools.

For example, the position sensor 87 may be changed to any other detection mechanism which is capable of detecting a push of the tool accessory 91, and its arrangement position may also be changed. For example, a non-contact type sensor (such as an optical sensor) other than a magnetic field detection type sensor, or a contact type detection mechanism (such as a mechanical switch) may be adopted. Further, a plurality of position sensors 87 or other detection mechanism(s) may be provided, depending on the detection type.

The elastic connecting structures between the first housing 21 and the second housing 22 in the electric hammers 11 to 13 and the elastic connecting structure between the body housing 23 and the handle 24 in the hammer drill 14 may be appropriately changed. For example, any one of the elastic members 281, 285, 261, and 255 may be formed by a spring other than the above-described example, rubber or synthetic resin. The number and the arrangement position of any one of the elastic members 281, 285, 261, and 255 may be appropriately changed. Further, it may be preferable that the position sensor 87 or other detection mechanism is disposed in the vicinity of the elastic member, as in the case of the embodiments.

In the electric hammer 13, the position sensor 87 is configured to detect a rearward movement of the movable unit 60 relative to the first housing 21 as a rearward push of the tool accessory 91. Therefore, in the electric hammer 13, the housing 20 may be configured as a single housing (which may be formed by fixedly connecting a plurality of parts) which does not have the elastic connecting structures of the above-described embodiments.

In a case where the position sensor 87 or other detection mechanism is configured to detect a movement of a member which moves together with the tool accessory 91 relative to the body housing for housing the motor and the driving mechanism, like in the third embodiment, the member which moves together with the tool accessory 91 is not limited to the movable unit 60 (the sleeve 63). For example, a relative movement of the impact bolt 463 may be detected, or a relative movement of a support body which supports the tool holder 49 and the cylinder 45 may be detected.

In the hammer drill 14 of the fourth embodiment, the position sensor 87 may be fixed above or below the spring-receiving part 260 to detect a push of the tool accessory 91 and an excessive-rotation state. Further, in the fourth embodiment, the position sensor 87 is used to detect a push of the tool accessory 91 and an excessive-rotation state, but it may be used to detect only either one of a push of the tool accessory 91 and an excessive-rotation state.

In the above-described embodiments, the switch 274 as a main power switch (for energizing the motor 3) is configured to be kept in the ON state while the trigger 27 is depressed. Further, the lock member 277 is provided to eliminate the need for continuing the depressing operation of the trigger 27. Therefore, the controller 81 may regard the main power switch as being in the ON state only when the trigger 27 is locked in the ON position, and may perform the push-on control based on the detection results of the position sensor 87. In this case, when the trigger 27 is not locked, the controller 81 may start and stop driving of the motor 3 only based on the ON/OFF state of the switch 274. The controller 81 may switch the control mode according to a detection result of a detection mechanism for detecting the position of the lock member 277. Further, the controller 81 may switch lighting mode of the LED of the LED unit 85 according to the control mode. Alternatively, in place of the trigger 27 and the switch 274, an alternate-type main power switch may be provided.

The LED unit 85 may be omitted. In other words, indication that the switch 274 is on (standby state) may be omitted. Further, indication may be made by buzzer sound or information display, in place of lighting of the LED.

The structures and arrangements of the motor 3, the driving mechanisms 4, 5 and the controller 81 and the structures of the housings for housing them may be appropriately changed. For example, the battery-mounting part 229 need not be provided in the second housing 22 or the handle 24 and may be provided in the first housing 21 or the body housing 23. The same is true for the controller 81. The motor 3 may be housed in the body housing such that the rotation axis of the motor shaft 35 extends in parallel to the driving axis A1, and only the upper end portion of a handle having a grip part may be elastically connected to the body housing in a cantilever manner.

In the above-described embodiment, as an example, the controller 81 is formed by a control circuit comprising the microcomputer, but it may be formed by a programmable logic device such as ASIC (Application Specific Integrated Circuits) and FPGA (Field Programmable Gate Array). Further, the driving control of the above-described embodiments and its modifications may be distributed to a plurality of control circuits.

Correspondences between the features of the above-described embodiments and modifications thereof and the features of the invention are as follows. However, these correspondences given here are non-limiting examples. Each of the electric hammers 11, 12, 13 and the hammer drill 14 is an example that corresponds to the “impact tool”. The motor 3 is an example that corresponds to the “motor”. Each of the driving mechanisms 4 and 5 is an example that corresponds to the “driving mechanism”. The driving axis A1 is an example that corresponds to the “driving axis”. The tool accessory 91 is an example that corresponds to the “tool accessory”. Each of the first housing 21 and the body housing 23 is an example that corresponds to the “body housing”. The battery-mounting part 229 is an example that corresponds to the “battery-mounting part”. The position sensor 87 is an example that corresponds to the “first detection part” and the “second detection part”. The controller 81 is an example that corresponds to the “control part”. Each of the second housing 22 and the handle 24 is an example that corresponds to the “elastically-connected part”. Each of the grip parts 221 and 241 is an example that corresponds to the “grip part”. Each of the elastic members 281, 285, 255, and 261 is an example that corresponds to the “elastic member”. The movable unit 60 is an example that corresponds to the “movable part”. Each of the switch 274 and the main power switch is an example that corresponds to the “main switch”. The LED unit 85 is an example that corresponds to the “indication part”.

In view of the nature of the present disclosure and the above-described embodiment, the following aspects are provided. One or more of the following aspects may be employed in combination with one or more of the above-described embodiments, modifications thereto and the claimed inventions.

### (Aspect 1)

The elastically-connected part includes:
the grip part extending substantially in an up-down direction;
an upper part extending forward from an upper end portion of the grip part; and
a lower part extending forward from a lower end portion of the grip part,

at least one of the upper part and the lower part is connected to the body housing via the at least one elastic member, and

the first detection part is disposed in the upper part or in the lower part.

The upper part 223 and the lower part 227 are examples that correspond to the “upper part” and the “lower part”, respectively, according to the present aspect.

### (Aspect 2)

The upper part is movably connected to the body housing via the at least one elastic member,

the lower part is connected to the body housing so as to be rotatable around a rotation axis extending in a left-right direction relative to the body housing, and

the first detection part is disposed in the upper part.

The upper connection part 26 and the lower connection part 25 are examples that correspond to the “upper part” and the “lower part”, respectively.

### (Aspect 3)

In aspect 2, the second detection part is disposed in the upper part.

### (Aspect 4)

The first detection part is disposed in the vicinity of the at least one elastic member.

### (Aspect 5)

The impact tool further includes a guide part configured to guide the body housing and the elastically-connected part to move at least in the front-rear direction relative to each other.

Each of the upper sliding part 201, the lower sliding part 202 and the sliding guide 203 is an example that corresponds to the “guide part” in the present aspect. The elongate hole 263 and the stopper part 239 are an example that corresponds to the “guide part” according to the present aspect.

Further, the following aspects 6 to 8 are provided in order to provide a rational structure for detecting a so-called excessive-rotation state in a hammer drill. Each of the following aspects 6 to 8 may be employed separately or in combination with each other, or in combination with one or more of the above-described embodiments, modifications thereto and the claimed inventions.

### (Aspect 6)

A hammer drill, comprising:

a motor;

a driving mechanism configured to linearly drive a tool accessory along a driving axis and to rotationally drive the tool accessory around the driving axis, by power of the motor, the driving axis extending in a front-rear direction of the hammer drill;

a body housing that houses the motor and the driving mechanism;

a handle connected to the body housing via at least one elastic member, the handle including a grip part to be held by a user;

a detection part configured to detect a movement of the handle relative to the body housing on a plane orthogonal to the driving axis; and

a control part configured to control driving of the motor, wherein:

the control part is configured to stop driving of the motor in a case where an amount of the relative movement on the plane detected by the detection part exceeds a specified amount.

In the hammer drill of the present aspect, the handle having the grip part is elastically and connected to the body housing so as to be movable relative to the body housing. Thus, when vibration is caused in the body housing when the tool accessory is driven, transmission of the vibration to the handle can be reduced. Further, when the tool accessory is rotationally driven, the body housing may excessively rotate around the driving axis (a so-called excessive-rotation state may be caused), for example, due to locking of the tool accessory to the workpiece. In this case, a twist may be caused around the driving axis between the body housing and the handle which are elastically connected to each other. This twist can be recognized as a movement (positional displacement) of the handle relative to the body housing on the plane orthogonal to the driving axis. According to the present aspect, by detecting this relative movement, the detection part can properly detect the excessive-rotation state. Then, the control part can properly stop driving of the motor based on this detection result.

The hammer drill 14 of the fourth embodiment is an example that corresponds to the “hammer drill” in the present aspect. The motor 3, the driving mechanism 5, the body housing 23, the handle 24 and the grip part 241 are examples that correspond to the “motor”, the “driving mechanism”, the “body housing”, the “handle” and the “grip part”, respectively, in the present aspect. The elastic members 255 and 261 are an example that corresponds to the “at least one elastic member” in the present aspect. The position sensor 87 is an example that corresponds to the “detection part” according to the present aspect. The controller 81 is an example that corresponds to the “control part” according to the present aspect.

The hammer drill of the present aspect may be operated by power supply from a removable battery or an external alternate current (AC) power source. Further, the structures of the above-described embodiments and modifications thereto can be suitably adopted as the structures of the body housing and the handle and the structure of elastically connecting them of the present aspect. As the detection part, any one of the position sensor 87 of the above-described embodiments and other detection mechanisms described as modifications thereof can be suitably adopted.

### (Aspect 7)

The hammer drill as defined in aspect 6, wherein:

the handle includes:
the grip part extending substantially in an up-down direction;
an upper connection part extending forward from an upper end portion of the grip part; and
a lower connection part extending forward from a lower end portion of the grip part,

the upper connection part is connected to the body housing via a first elastic member so as to be movable relative to the body housing,

the lower connection part is connected to the body housing so as to be rotatable around a rotation axis relative to the body housing, the rotation axis extending in a left-right direction, and

the detection part is disposed in the upper connection part.

According to the present aspect, the detection part may be disposed in the upper connection part apart from the rotation axis. In this position, the swing width of the handle (the upper connection part) relative to the body housing (the amount of a movement of the handle relative to the body housing) is relatively large compared with that in the vicinity of the rotation axis. Therefore, the detection part can accurately detect an excessive-rotation state. The upper connection part 26 and the lower connection part 25 of the fourth embodiment are examples that correspond to the “upper connection part” and the “lower connection part”, respectively, according to the present aspect. The elastic member 261 is an example that corresponds to the “first elastic member” according to the present aspect.

### (Aspect 8)

The hammer drill as defined in aspect 7, wherein the lower connection part is connected to the body housing via a second elastic member so as to be movable relative to the body housing, the second elastic member being disposed around the rotation axis.

According to the present aspect, transmission of vibration to the handle can be more effectively suppressed by the second elastic member. Further, when an excessive-rotation state is caused, a twist is more reliably generated around the driving axis, so that the detection accuracy of the detection part can be enhanced. The elastic member 255 of the fourth embodiment is an example that corresponds to the “second elastic member” according to the present aspect.

### DESCRIPTION OF NUMERALS

11, 12, 13: electric hammer, 14: hammer drill, 20: housing, 201: upper sliding part, 202: lower sliding part, 203: sliding guide, 204: pin, 206: shoulder part, 207: recess, 21: first housing, 211: motor-housing part, 217: driving-mechanism-housing part, 218: rear wall part, 219: protrusion, 22: second housing, 221: grip part, 223: upper part, 227: lower part, 228: controller-housing part, 229: battery-mounting part, 23: body housing, 231: motor-housing part, 232: protruding part, 237: driving-mechanism-housing part, 238: support wall, 239: stopper part, 24: handle, 241: grip part, 243: controller-housing part, 25: lower connection part, 251: shaft part, 253: recess, 255: elastic member, 26: upper connection part, 260: spring-receiving part, 261: elastic member, 263: slot, 27: trigger, 271: projection, 274: switch, 277: lock member, 278: projection, 281: elastic member, 282: spring-receiving part, 283: spring-receiving part, 285: elastic member, 286: support wall, 287: spring-receiving recess, 290: stopper part, 291: projection piece, 292: recess, 293: wall part, 294: wall part, 297: stopper part, 3: motor, 35: motor shaft, 4: driving mechanism, 40: motion-converting mechanism, 41: crank shaft, 42: connecting rod, 43: piston, 45: cylinder, 46: striking mechanism, 49: tool holder, 5: driving mechanism, 50: motion-converting mechanism, 51: intermediate shaft, 52: rotary body, 53: swinging member, 55: piston cylinder, 57: rotation-transmitting mechanism, 60: movable unit, 61: receiving part, 63: sleeve, 65: pin, 67: elastic member, 81: controller, 83: speed-change dial unit, 85: LED unit, 87: position sensor, 88: magnet, 91: tool accessory, 93: battery, 461: striker, 463: impact bolt, 464: large diameter part, 490: chuck, 491: ball, 875: substrate, 911: groove, A1: driving axis, A2: rotation axis

What is claimed is:

1. An impact tool, comprising:
a motor;
a driving mechanism configured to linearly drive a tool accessory along a driving axis by power of the motor, the driving axis extending in a front-rear direction of the impact tool;
a body housing that houses the motor and the driving mechanism;
a battery-mounting part configured to removably receive a battery, the battery being a power source of the motor;
a first detection part configured to detect a rearward push of the tool accessory relative to the body housing; and
a control part configured to control driving of the motor, wherein:
the control part is configured to start driving of the motor in response to detection of the rearward push of the tool accessory by the first detection part.

2. The impact tool as defined in claim 1, further comprising:
an elastically-connected part connected to the body housing via at least one elastic member so as to be movable relative to the body housing, the elastically-connected part including a grip part to be held by a user, wherein:
the first detection part is configured to detect, as the rearward push of the tool accessory, a forward movement of the elastically-connected part relative to the body housing.

3. The impact tool as defined in claim 2, wherein the first detection part is disposed in the elastically-connected part.

4. The impact tool as defined in claim 2, wherein the first detection part is disposed in the vicinity of the at least one elastic member.

5. The impact tool as defined in claim 2, further comprising:
at least one guide part configured to guide the body housing and the elastically-connected part to move at least in the front-rear direction relative to each other.

6. The impact tool as defined in claim 2, wherein:
the grip part extends in an up-down direction orthogonal to the driving axis,
the elastically-connected part includes an upper part extending forward from an upper end portion of the grip part and a lower part extending forward from a lower end portion of the grip part,
at least one of the upper part and the lower part is connected to the body housing via the at least one elastic member, and
the first detection part is disposed in the upper part or in the lower part.

7. The impact tool as defined in claim 2, further comprising:
a second detection part configured to detect a movement of the elastically-connected part relative to the body housing on a plane orthogonal to the driving axis, wherein:
the driving mechanism is further configured to rotate the tool accessory around the driving axis by the power of the motor,
the control part is configured to stop driving of the motor in a case where an amount of the relative movement on the plane detected by the second detection part exceeds a specified amount.

8. The impact tool as defined in claim 7, wherein the first detection part is configured to also serve as the second detection part.

9. The impact tool as defined in claim 8, wherein
the grip part extends in an up-down direction orthogonal to the driving axis,
the elastically-connected part includes an upper part extending forward from an upper end portion of the grip part and a lower part extending forward from a lower end portion of the grip part,
the upper part is movably is connected to the body housing via the at least one elastic member,
the lower part is connected to the body housing so as to be rotatable around a rotation axis relative to the body housing, the rotation axis extending in a left-right direction orthogonal to both the front-rear direction and the up-down direction, and
the first detection part is disposed in the upper part.

10. The impact tool as defined in claim 7, wherein the control part is configured to maintain the motor in a non-driven state until a specified reset operation is performed by a user after the control part once stops driving of the motor according to a detection result of the second detection part.

11. The impact tool as defined in claim 1, further comprising:
a movable part configured to move rearward together with the tool accessory relative to the body housing by interlocking with the rearward push of the tool accessory, wherein:
the first detection part is configured to detect, as the rearward push of the tool accessory, a rearward movement of the movable part relative to the body housing.

12. The impact tool as defined in claim 1, wherein the control part is configured to stop driving of the motor when a specified time elapses after the first detection part detects a release of the rearward push of the tool accessory.

13. The impact tool as defined in claim 1, further comprising:
a main switch configured to be switched between an ON state and an OFF state according to a user's external operation, wherein:
the control part is configured to start driving of the motor in response to detection of the rearward push of the tool accessory by the first detection part only when the main switch is in the ON state.

14. The impact tool as defined in claim 13, further comprising an indication part configured to indicate information that the main switch is in the ON state.
